(19) United States
(12) Patent Application Publication
(10) Pub. No.: US 2024/0210925 A1
(43) Pub. Date: Jun. 27, 2024

(54) METHOD AND APPARATUS WITH OPERATIONAL CONTROL DEPENDENT ON MULTIPLE PROCESSES

(71) Applicant: SAMSUNG ELECTRONICS CO., LTD., Suwon-si (KR)

(72) Inventors: Dong Jin JI, Suwon-si (KR); Kaeweon YOU, Suwon-si (KR); Jiung LEE, Suwon-si (KR); Seok Hyun HONG, Suwon-si (KR)

(73) Assignee: SAMSUNG ELECTRONICS CO., LTD., Suwon-si (KR)

(21) Appl. No.: 18/530,692

(22) Filed: Dec. 6, 2023

(30) Foreign Application Priority Data
Dec. 22, 2022 (KR) 10-2022-0182233

(51) Int. Cl. G05B 19/418

(52) U.S. Cl. CPC G05B 19/41865; G05B 2219/45031

(57) ABSTRACT

A method including generating sequence data based on measured values of respective one or more process factors of each of a plurality of processes of a semiconductor fabrication process for a wafer within the semiconductor fabrication process, generating a temporary quality index of the wafer using a second neural network connected to a first neural network that is provided the sequence data, training the first neural network and the second neural network based on a loss between the temporary quality index and a set actual quality index of the wafer, selecting a control process from among the plurality of processes using at least one of the trained first neural network and/or the trained second neural network, and selecting a control factor from among multiple process factors of the selected process using the trained second neural network.

### CROSS-REFERENCE TO RELATED APPLICATIONS

This application claims priority under 35 USC § 119(a) to Korean Patent Application No. 10-2022-0182233 filed on Dec. 22, 2022, in the Korean Intellectual Property Office, the disclosure of which is incorporated by reference herein in its entirety.

### BACKGROUND

### 1. Field

The following description relates to a method and apparatus with operational control dependent on multiple processes.

### 2. Description of Related Art

Selecting a control factor that has a particular influence on a quality index of a wafer may typically include selection of the control factor that belongs to a particular individual or single process using measured values obtained by a sensor or device when the wafer is at a corresponding operation stage that performs that process. For example, when a wafer is at an operation stage corresponding to an exposure process, the shape of a wafer may be measured using an electron microscope, and a control factor of the exposure process may be selected based on the measured shape of the wafer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a method including generating sequence data based on measured values of respective one or more process factors of each of a plurality of processes of a semiconductor fabrication process for a wafer within the semiconductor fabrication process, generating a temporary quality index of the wafer using a second neural network connected to a first neural network that is provided the sequence data, training the first neural network and the second neural network based on a loss between the temporary quality index and a set actual quality index of the wafer, selecting a control process from among the plurality of processes using at least one of the trained first neural network and/or the trained second neural network, and selecting a control factor from among multiple process factors of the selected process using the trained second neural network.

The first neural network may be trained to infer process factors, from among all the process factors belonging to the plurality of processes, that affect quality more than other control factors of the all control factors.

The second neural network may include a transformer encoder and a multi-layer perceptron (MLP).

The generating of the temporary quality index may include correcting the generated sequence data in response to inputting the sequence data to the first neural network, generating, by the second neural network, a plurality of embedding vectors by performing linear projection on each of the corrected sequence data to be respective vectors of the plurality of embedding vectors having a preset size, and generating, by the second neural network, the temporary quality index of the wafer using the MLP provided an output vector of the transformer encoder that is provided the plurality of embedding vectors.

The transformer encoder may perform positional encoding on each of the plurality of embedding vectors and providing embedding vectors obtained through the positional encoding to the transformer encoder.

The transformer encoder may include a plurality of encoders, each encoder including a multi-head attention layer configured to perform self-attention at least once, the plurality of encoders being connected in series.

The training may include performing the training of the first neural network and the second neural network together and retraining the second neural network using the trained first neural network.

The selecting of the control process may include selecting a preset number of processes as the control process from among the plurality of processes, in a descending order from a corresponding process that has a greatest number of respective process factors selected by the trained first neural network.

In a general aspect, the selecting of the control process may include for each of the plurality of processes calculating a respective score indicating an interaction between a corresponding process and other processes for each of plural wafers using a transformer encoder of the trained second neural network, calculating an average of the respective scores as a respective final score of the corresponding process, and selecting a preset number of select processes as the control process from among the plurality of processes, in a descending order from a process having a highest respective final score.

The selecting of the control process may include, for each of some process factors selected by the trained first neural network from among all the process factors of the plurality of processes calculating a Shapley value of a corresponding process factor for each of plural wafers using a transformer encoder of the trained second neural network, and calculating an average of absolute values of the Shapley values calculated for plural wafers as a respective final score of the corresponding process factor, and selecting a preset number of select process factors as the control factor from among the some process factors in a descending order according to the respective final score of the select process factors from a process factor having a highest respective final score.

In a general aspect here is provided an electronic device including a processor configured to generate sequence data based on measured values of respective one or more process factors of each of a plurality of processes of a semiconductor fabrication process for a wafer within the semiconductor fabrication process, generate a temporary quality index of the wafer using a second neural network connected to a first neural network that is provided the sequence data, train the first neural network and the second neural network based on a loss between the temporary quality index and a set actual quality index of the wafer, select a control process from among the plurality of processes using at least one of the trained first neural network or the trained second neural network, and select a control factor from among multiple process factors of the selected process using the trained second neural network.

The first neural network may be trained to infer process factors, from among all the process factors belonging to the plurality of processes, that affect quality more than other control factors of the all control factors.

The second neural network may include a transformer encoder and a multi-layer perceptron (MLP).

The generating of the temporary quality index may include correcting the generated sequence data in response to inputting the sequence data from to first neural network, generating, by the second neural network, a plurality of embedding vectors by performing linear projection on each of the corrected sequence data to be respective vectors of the plurality of embedding vectors having a preset size, and generating, by the second neural network, the temporary quality index of the wafer using the MLP provided an output vector of the transformer encoder that is provided the plurality of embedding vectors.

The processor may be configured to perform positional encoding on each of the plurality of embedding vectors and provide embedding vectors obtained through the positional encoding to the transformer encoder.

The transformer encoder may include a plurality of encoders, each encoder including a multi-head attention layer configured to perform self-attention at least once, the plurality of encoders being connected in series.

The processor may be configured to train both the first neural network and the second neural network together and retrain the second neural network using the trained first neural network.

The processor may be configured to select a preset number of processes as the control process from among the plurality of processes, in a descending order from a corresponding process that has a greatest number of respective process factors selected by the trained first neural network.

In a general aspect, the processor may be configured to, for each of the plurality of processes calculate a respective score indicating an interaction between a corresponding process and other processes for each of plural wafers using a transformer encoder of the trained second neural network, and calculate an average of the respective scores as a respective final score of the corresponding process, and select a preset number of select processes as the control process from among the plurality of processes, in a descending order according to the respective final scores of the select processes from a process having a respective highest final score.

The processor may be configured to, for each of some process factors selected by the trained first neural network from among all the process factors of the plurality of processes calculate a Shapley value of a corresponding process factor for each of wafers using a transformer encoder of the trained second neural network, calculate an average of absolute values of the Shapley values calculated for the plural wafers as a respective final score of the corresponding process factor, and select a preset number of select process factors as the control factor from among the some process factors in a descending order according to the respective final scores of the selected process factors from a process factor having a highest respective final score.

In a general aspect, here is provided a processor-implemented method including training a first neural network on sequence data of a wafer formed by a semiconductor fabrication process to infer relevant process factors for sequence operations of the sequence data, iteratively correcting, by the first neural network, the sequence data according to respective relevant portion factors, training a second neural network to generate a temporary quality index of the wafer based on the corrected sequence data, and training the first neural network and the second neural network based on a loss between the temporary quality index and an actual quality index of the wafer.

The method may include selecting, by the first neural network, a first preset ratio of process factors of the sequence data as a first portion of the process factors and selecting, by the first neural network, a second preset ratio of the first portion as the relevant process factors.

The selecting of the first portion and the selecting of the second portion may be performed in the first neural network by according to automatic factor selection algorithm.

The automatic factor selection algorithm may be a stochastic gate (STG) algorithm.

The method may include selecting a control factor from among the relevant process factors using the trained second neural network.

Other features and aspects will be apparent from the following detailed description, the drawings, and the claims.

### BRIEF DESCRIPTION OF THE DRAWINGS

FIG. 1 illustrates an example operational flow and an electronic device, in accordance with one or more embodiments.

FIG. 2 illustrates an example operational flow and an electronic device, in accordance with one or more embodiments.

FIG. 3 illustrates an example operational flow and structure of a transformer encoder included in a neural network of an electronic device, in accordance with one or more embodiments.

FIGS. 4 and 5 illustrate examples of a control process, in accordance with one or more embodiments.

FIG. 6 illustrates an example of selecting a control factor using a trained second neural network by an electronic device, in accordance with one or more embodiments.

FIGS. 7 and 8 illustrate examples of selecting a control factor by an electronic device, in accordance with one or more embodiments.

FIG. 9 illustrates an example apparatus with control process and control factor selection, in accordance with one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

A typical control factor selecting technology which selects a control factor of a single process, which is among many processes of a semiconductor fabrication process, may not be able to effectively reflect interdependent characteristics of the semiconductor process, such as when there are thousands of processes interacting with each other throughout the whole semiconductor fabrication process. For example, in a case in which two or more processes affect each other, it is likely that the quality of a wafer may deteriorate with such a typical control factor selection. For example, it is likely that a typical control factor selecting technology may not effectively select a correct control factor when only accounting for a single process. Indeed, it is unlikely that there is only one process that would affect a quality index of a wafer in a general semiconductor fabrication process, and thus selecting and adjusting a control factor, considering only a single process without considering the interaction between multiple processes, is likely to result in a low quality fabricated wafer.

In a semiconductor fabrication process, thousands of processes are performed in succession, where a preceding process may greatly affect a subsequent process. In addition, there may be interactions between a plurality of processes among the thousands of processes included in the semiconductor fabrication process. For example, a molding process may interact with other processes. The molding process may be a first performed process among the many processes included in the semiconductor fabrication process, where next processes may sequentially include stacking various materials on a surface of a wafer. For example, when particles are introduced between layers during the molding process, the layers that may be stacked afterwards may not be level which may cause a defect in a shape of the wafer in following processes, such as in an exposure process or an etching process. However, the defect generated in the molding process may not be detected by only one or more sensors measuring values during the exposure process or the etching process. That is, in the exposure process, a defect that occurs because of an interaction between the exposure process and the molding process may not be recognized, and in the etching process, a defect caused by an interaction between the etching process and the molding process may likewise not be recognized.

A typical control factor selecting technology may select a control factor belonging to a single process as a target. This typical control factor selecting technology may select a control factor by applying only a single process without considering an interaction between that process and other processes included in a semiconductor fabrication process and may thus fail to select an appropriate control factor. In contrast, an electronic device according to one or more example embodiments described herein may select a control process and a control factor in consideration of one or more interactions between a plurality of processes of the semiconductor fabrication process.

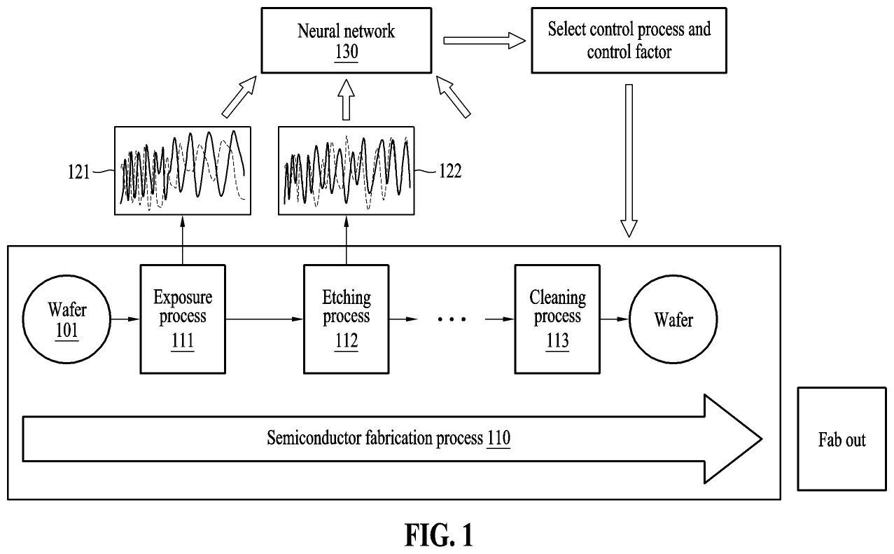

FIG. 1 illustrates an example operational flow and an electronic device according to one or more embodiments.

In a non-limiting example, an electronic device (e.g., a neural network) may select a control process that has a determined larger effect on a quality index of a wafer than other processes that are also performed on the wafer in a semiconductor manufacturing process (or hereinafter, a semiconductor fabrication process 110). In an example, the electronic device may select a control factor that has a larger effect on the quality index of the wafer than other process factors that are among the plurality of processes.

In a non-limiting example, the electronic device may obtain measured values of process factors for a wafer 101 that belong to a process for each of a plurality of processes (e.g., an exposure process 111, an etching process 112, a cleaning process 113, etc.) performed on the wafer 101 in the semiconductor fabrication process 110. For example, the electronic device may obtain measured values of process factors for the wafer 101 that belong to a single process, through a sensor or other device of/at a corresponding operation stage that performs that process. For example, graphs 121 and 122 shown in FIG. 1 may indicate measured values of process factors for the wafer 101 that belong to the exposure process 111 and the etching process 112, respectively.

The electronic device may obtain respective measured values of process factors for the wafer 101 that belong to the plurality of processes included in the semiconductor fabrication process 110 using sensors or other devices of/at corresponding operation stages. As a non- limiting example, a wafer may be moved among plural operation stages, which each include respective hardware to perform the corresponding processes of the semiconductor fabrication process. Alternatively, the process may be performed at a single operational stage. The electronic device may train a neural network 130 using the measured values obtained for the wafer 101. The electronic device may then use the trained neural network 130 to select one or more control processes that have a determined (e.g., inferred) substantial influence on a quality index of the wafer 101 from among the plurality of processes and thereby select one or more control factors having a substantial (e.g., a major) influence on the quality index of the wafer 101 from among all process factors belonging to the plurality of processes. The electronic device may improve the quality index of the wafer 101 by adjusting one or more of the selected control processes and the selected control factors in the semiconductor fabrication process 110. As will be described in greater detail below, the neural network 130 may include a first neural network and a second neural network.

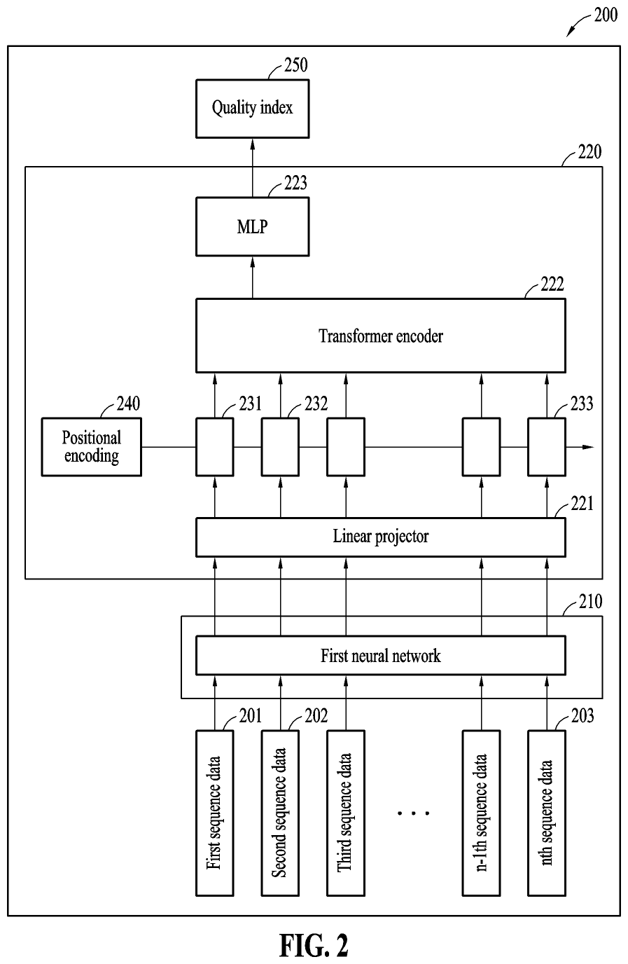

FIG. 2 illustrates an example operational flow and an electronic device, in accordance with one or more embodiments.

In a non-limiting example, an electronic device 200 may include a first machine learning model 210 and a second machine learning model 220.

In an example, the electronic device 200 may generate one or more sequence data based on measured values of process factors for a wafer that belong to a process, for each process among a plurality of processes that are included in a semiconductor fabrication process. For example, for a single wafer, the electronic device 200 may generate first sequence data 201 based on measured values of process factors belonging to a first process and may generate second sequence data 202 based on measured values of process factors belonging to a second process. In an example, when the semiconductor process includes n processes, the electronic device may generate n pieces of sequence data for each of n processes, respectively. In an example, the number n may be a natural number greater than or equal to 2. For example, the electronic device 200 may generate, as one sequence data (e.g., the first sequence data 201), a vector including, as elements, measured values of process factors belonging to one process (e.g., the first process).

The electronic device 200 may input (provide) the plurality of sequence data generated for each of the plurality of processes for one wafer to the first machine learning model 210, hereinafter referred to as first neural network 210 for non-limiting explanatory purposes. The electronic device 200 may obtain a temporary quality index of the one wafer that is output from the second machine learning model 220, hereinafter referred to as second neural network 220 for non-limiting explanatory purposes connected to the first neural network 210, based on the input (provision) of the generated plurality of sequence data to the first neural network 210.

In an example, the first neural network 210 may be a neural network configured to infer relevant process factors from among all process factors belonging to the plurality of processes. That is, the first neural network 210 may select a portion of the available process factors of the plurality of processes for the semiconductor fabrication process because the selected portion of process factors may have an inferred greater impact on the semiconductor fabrication process than others. The first neural network 210 may select process factors from among all the process factors belonging to the plurality of processes, using an automatic factor selection algorithm (e.g., a stochastic gate algorithm or STG algorithm) or by the first neural network 210 being trained to perform the same. The expression “selecting a process factor” described herein may be construed as selecting an element corresponding to a measured value of the corresponding process factor from a vector. For example, the first neural network 210 may select a first preset ratio (e.g., 80%) of process factors from among all the process factors using the STG algorithm and select a second preset ratio (e.g., 80%) of process factors from among the first selected process factors by again using the STG, or another, algorithm. The first neural network 210 may select a final preset number of process factors from among all the process factors (e.g., the first process factors and the second process factors) by repeatedly using the STG algorithm. The final preset number of process factors selected by first neural network 210 may include any number of iterations of selecting the process factors by the STG algorithm.

The electronic device 200 may correct a plurality of sequence data in response to inputting (providing) the plurality of sequence data to the first neural network 210. That is, the electronic device 200 may obtain the corrected plurality of sequence data from an output of the first neural network 210. As described above, the first neural network 210 may select some process factors (e.g., the “relevant” or final process factors and/or one or more selected process factors) from among all the process factors belonging to the plurality of processes according to the automatic factor selection algorithm. For each one of the one or more sequence data, the first neural network 210 may correct the sequence data such that the corrected sequence data has information about a measured value corresponding to a selected process factor. In an example, the corrected sequence data may have only information about the measured value that corresponds to the selected process factor. For example, the first sequence data 201 may be a vector (e.g., v₁, v₂, v₃, v₄) including, as its elements, measured values of respective process factors a₁, a₂, a₃, and a₄, and the first neural network 210 may select process factors a₁ and a₂ from among the process factors a₁, a₂, a₃, and a₄. In this example, the first neural network 210 may correct the first sequence data 201 to be a vector (e.g., (v₁, v₂)) including measured values of the process factors a₁ and a₂. In a non-limiting example, the correction may be performed iteratively across each or one or more of the sequence data to obtain the corrected sequence data corresponding to a selected process factor such as by iteratively inputting a new vector to the first neural network 210 without the sequence data that has already been corrected, or a new vector to the first neural network 210 with the sequence data except with corresponding zero values for those sequence data that have already been corrected. In an example, the correction may be performed across the sequence data for each selected process factor, and below operations of the second neural network may be repeated for each generated corrected sequence data.

In a non-limiting example, the second neural network 220 may include a linear projector 221, a transformer encoder 222, and a multi-layer perceptron (MLP) neural network 223 (hereinafter, simply “MLP” 223), as a non-limiting example. The electronic device 200 may generate a plurality of embedding vectors to be input to the transformer encoder 222, in response to inputting the corrected plurality of sequence data to the linear projector 221.

In an example, the electronic device 200 may obtain the plurality of embedding vectors in response to inputting the corrected plurality of sequence data to the linear projector 221. The linear projector 221 may perform linear projection on an input vector to generate an output vector having a preset size. That is, the linear projector 221 may generate the plurality of embedding vectors (e.g., a first embedding vector 231, a second embedding vector 232, etc.) by performing a trained linear projection on each of the corrected plurality of sequence data to be the vector having the preset size. The operations of the linear projector 221 may also be performed by a processor of the electronic device 200 through a separate neural network or a non-neural network linear projection algorithm instead.

In a non-limiting example, the electronic device 200 may input the plurality of embedding vectors to the transformer encoder 222. For example, the electronic device 200 may be trained to perform positional encoding 240 on each of the generated plurality of embedding vectors, and the electronic device 200 may input the embedding vectors obtained through the positional encoding 240 to the transformer encoder 222. The positional encoding 240 may refer to an operation of adding sequence information of each embedding vector. For example, the electronic device 200 may add an encoding vector indicating a first order to a first embedding vector 231 and add an encoding vector indicating a second order to a second embedding vector 232. The electronic device 200 may add an encoding vector to each of the embedding vectors before the embedding vectors are used as an input of the transformer encoder 222. Also, the electronic device 200 may additionally input a learnable class token to the transformer encoder 222 in front of the embedding vectors. An encoding vector indicating a zeroth (0th) order may be added to the class token. The electronic device 200 may add the encoding vector to each of the embedding vectors (e.g., the first embedding vector 231, the second embedding vector 232, an nth embedding vector 233, etc.) and the class token, and may then input a result thereof to the transformer encoder 222.

The transformer encoder 222 may be trained to map each of the input plurality of embedding vectors to one process. For example, the transformer encoder 222 may map the first embedding vector 231 to a first process and map the second embedding vector 232 to a second process. The transformer encoder 222 may perform self-attention on the input plurality of embedding vectors to calculate, as a score, an interaction between a process corresponding to one embedding vector and other processes corresponding to other embedding vectors.

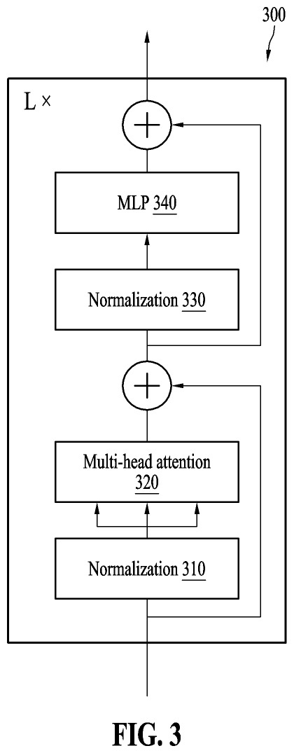

FIG. 3 illustrates an example operational flow and structure of a transformer encoder included in a neural network of an electronic device (e.g., electronic device 200 of FIG. 2), in accordance with one or more embodiments. Referring to FIG. 3, in a non-limiting example, a transformer encoder 300 (e.g., the transformer encoder 222 of FIG. 2) may include a plurality of encoders connected in series. For example, the transformer encoder 300 may include L encoders that are connected in series. In an example, L may be a natural number greater than or equal to 2. It may be understood that, in the transformer encoder 300, an output of one encoder may be an input of a subsequent encoder, and an output of a last encoder may be an output of the transformer encoder 300. The transformer encoder 300 may include a plurality of encoders each including a multi-head attention layer configured to perform self-attention at least once and connected in series to each other.

In an example, the transformer encoder 300 may perform normalization 310 on input embedding vectors that are input to the transformer encoder 300. For example, the transformer encoder 300 may perform layer normalization on the input embedding vectors. After the normalization, the transformer encoder 300 may perform multi-head attention 320 in which self-attention is performed at least once. The transformer encoder 300 may perform residual connection by adding the input embedding vectors and output vectors from the multi-head attention 320. The transformer encoder 300 may perform normalization 330 on a matrix calculated by the residual connection. The transformer encoder 300 may input the normalized matrix to an MLP 340. For example, the MLP 340 may include two layers in which an embedding size may be expanded in a first layer and the embedding size may be restored to an original size in a second layer. The transformer encoder 300 may calculate output embedding vectors by adding the matrix output from the MLP 340 and the matrix calculated by the residual connection. The calculated output embedding vectors may be used as input embedding vectors of a subsequent encoder.

Referring back to FIG. 2, in an example, the electronic device 200 may obtain a temporary quality index of a wafer, in response to inputting, to the MLP 223, an output vector that is output from the transformer encoder 222. The MLP 223 may be trained to predict a quality index 250 of the wafer using the output vector of the transformer encoder 222. The electronic device may obtain, as the temporary quality index, the quality index 250 of the wafer predicted by the MLP 223. For example, the electronic device 200 may determine input data of the MLP 223 using only a class token input to the transformer encoder 222. The electronic device 200 may determine, as the input data of the MLP 223, an output vector obtained as the class token is output through the plurality of encoders included in the transformer encoder 222. The MLP 223 may perform classification by allowing the output vector corresponding to the class token to pass through a linear layer and may predict the quality index 250 of the wafer as the classification is performed.

In an example, the electronic device 200 may train the first neural network 210 and the second neural network 220 based on a determined loss between the obtained temporary quality index of the wafer and an actual quality index of the wafer. For example, the electronic device 200 may further train both the first neural network 210 and the second neural network 220 together, and may continue training of the second neural network 220 with the first neural network 210 being fixed (e.g., with training of the first neural network 210 may have been determined to be complete by the electronic device 200)completed its training. The training of neural networks will be described in greater detail below.

In an example, the electronic device 200 may train the first neural network 210 and the second neural network 220 together. For example, the electronic device 200 may generate a plurality of sequence data (e.g., the first sequence data 201, the second sequence data 202, etc.) for a wafer, and obtain a first temporary quality index (e.g., quality index 250) of the wafer that is output from the second neural network 220 connected to the first neural network 210 in response to inputting the generated plurality of sequence data to the first neural network 210. The electronic device 200 may set the plurality of sequence data for the wafer as training input data and set an actual quality index of the wafer as training output data. The electronic device 200 may train the first neural network 210 and the second neural network 220 such that the training output data is output from the training input data accurately. That is, the electronic device 200 may train both the first neural network 210 and the second neural network 220 together such that a first loss between the first temporary quality index and the actual quality index is minimized. During the training, parameters (e.g., connection weights between nodes and layers) of the first neural network 210 and the second neural network 220 may be iteratively updated based on each iteratively calculated first loss.

After training the first neural network 210 and the second neural network 220 together, the electronic device 200 may train the second neural network 220 further using the trained first neural network 210. That is, the electronic device 200 may update only the parameters of the second neural network 220 while the parameters of the first neural network 210 may remain fixed. That the parameters of the first neural network 210 are fixed may indicate that the process factors selected by the first neural network 210 from among all the process factors are predetermined. That is, the electronic device 200 may train the second neural network 220 further in a state in which one or more process factors selected by the first neural network 210 are predetermined (i.e., fixed) among all the process factors. The electronic device 200 may generate a plurality of sequence data for a wafer, and obtain a second temporary quality index of the wafer that is output from the second neural network 220 connected to the trained first neural network 210 in response to inputting the generated plurality of sequence data to the first trained neural network 210. The electronic device 200 may set the plurality of sequence data for the wafer as training input data and set an actual quality index of the wafer as training output data. The electronic device 200 may train the second neural network 220 such that the training output data is output from the training input data. That is, the electronic device 200 may train the second neural network 220 such that a second loss between the second temporary quality index and the actual quality index is minimized. During the training, the electronic device 200 may train only the parameters of the second neural network 220 based on the second loss, while the parameters of the first neural network 210 are fixed.

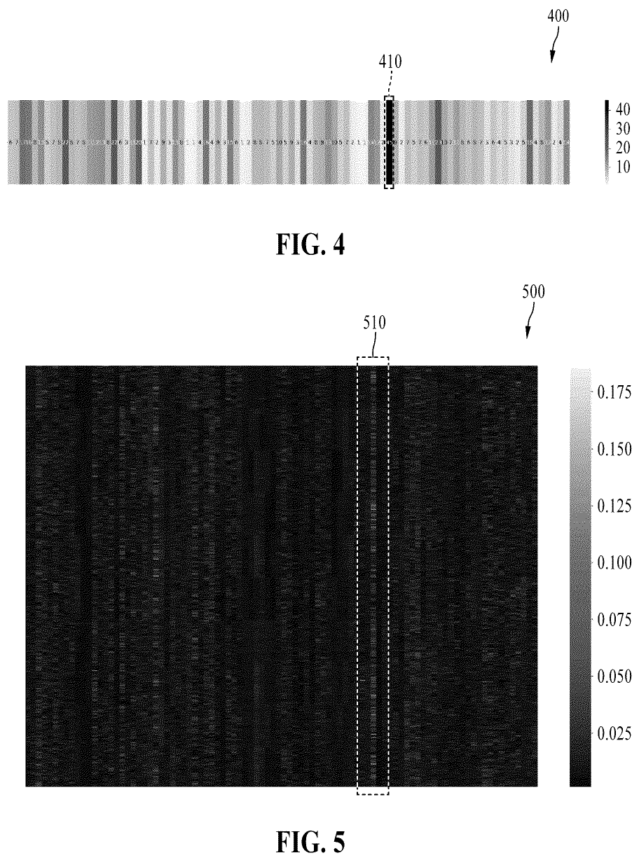

FIGS. 4 and 5 illustrate examples of a control process, in accordance with one or more embodiments.

In a non-limiting example, an electronic device may train a first neural network (e.g., the first neural network 210 of FIG. 2) and a second neural network (e.g., the second neural network 220 of FIG. 2). The electronic device may use at least one of the trained first neural network or the trained second neural network to select (infer) a control process that has a major influence on a quality index of a wafer from among a plurality of processes included in a semiconductor process.

Referring to FIG. 4, in a non-limiting example, the electronic device may use the trained first neural network to select (infer) a control process that has a major influence on a quality index of a wafer from among a plurality of processes included in a semiconductor process. That is, in an example, the first neural network may select relevant process factors from among all process factors. In an example, the electronic device may determine, as a process that has a greater influence on the quality index of the wafer, a process to which a larger number of process factors selected by the first neural network belong. The electronic device may identify some process factors selected by the trained first neural network from among all the process factors belonging to the plurality of processes as relevant or those that greatly affect wafer quality, and may calculate the number of process factors selected by the trained first neural network from among process factors belonging to a process for each of the plurality of processes. FIG. 4 illustrates an example heatmap 400 that may be an example of an image in which the number of process factors selected by the trained first neural network from among process factors belonging to each of the plurality of processes is indicated. An x-axis of the heatmap 400 may indicate each process. In an example, the electronic device may select, as a control process, a process (e.g., a process 410) to which the process factors selected by the trained first neural network belong the most, from among all the processes included in the semiconductor process. In the example heatmap 400, there are 45 process factors illustrated as being selectable by the trained first neural network from among the various process factors belonging to the process 410. In another example, the electronic device may select, as control processes, a preset number (e.g., five) of processes in order from a process including the greatest number of the process factors selected by the trained first neural network from among all the processes.

Referring to FIG. 5, in a non-limiting example, the electronic device may use the trained second neural network to select a control process that has a greater (e.g., a major) influence on a quality index of a wafer from among a plurality of processes included in a semiconductor process. The electronic device may generate an attention map for one wafer by using a transformer encoder (e.g., the transformer encoder 222 of FIG. 2) included in the trained second neural network. The attention map may represent a table in which a score indicating an interaction between a process corresponding to one embedding vector input to the transformer encoder and other processes corresponding to other embedding vectors is stored. The electronic device may determine that a process having a higher score indicating an interaction with other processes is a process that has a greater (e.g., a major) influence on a quality index of the wafer. The electronic device may generate an attention map for each of individual wafers from the transformer encoder included in the second neural network and may generate an attention heatmap 500 based on a plurality of attention maps generated for the respective wafers. The attention heatmap 500 may be an image visually representing the plurality of attention maps generated for the respective wafers. In the attention heatmap 500, an x-axis may indicate a process corresponding to each embedding vector, and a y-axis may indicate an index of each wafer. In the attention heatmap 500, the brightness of a color indicated at one point may be the brightness corresponding to a score indicating an interaction between a process corresponding to an x-axis coordinate of the one point and other processes. For example, the electronic device may increase the color brightness as the score increases and may decrease the color brightness as the score decreases. In an example, for each of the plurality of processes, the electronic device may calculate a score indicating an interaction between a corresponding process and other processes using the transformer encoder (e.g., the transformer encoder 222 of FIG. 2) included in the trained second neural network for each of the individual wafers and calculate an average of scores calculated for the respective wafers as a final score of the corresponding process. The electronic device may select a control process that has an influence above a predetermined amount of influence, or an influence score, (e.g., a major influence) on a quality factor of a wafer from among all the processes by comparing final scores calculated for the respective processes to each other. In an example, one or more processes may be considered as having a major influence if their respective final scores are above a predetermined threshold (e.g., having a score of 0.170 or greater as illustrated in attention heatmap 500) or if one or more final scores are larger than a predetermined percentage of the other final scores (e.g., 99% percentile scores).

In an example, the electronic device may select, as the control process, a process (e.g., a process 510) having the highest final score among the plurality of processes included in the semiconductor process. In another example, the electronic device may select, as the control process, a preset number (e.g., five) of processes in order from a process having the highest final score among the plurality of processes.

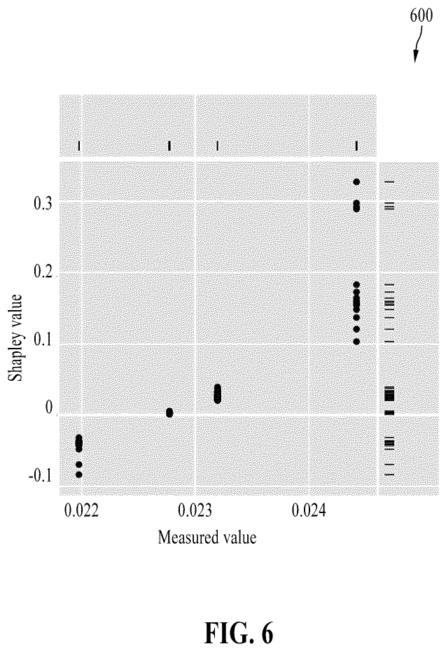

FIG. 6 illustrates an example of a control factor, in accordance with one or more embodiments.

In a non-limiting example, an electronic device (e.g., the electronic device 200 of FIG. 2) may use a trained second neural network to select a control factor that has a major influence on a quality index of a wafer from among all process factors. For each of a plurality of wafers, the electronic device may calculate a Shapley value of each of the process factors using a transformer encoder (e.g., the transformer encoder 222 of FIG. 2) included in the trained second neural network.

The electronic device may calculate a Shapley value of each process factor through a Shapley algorithm (e.g., a Shapley additive explanation (SHAP)), using the transformer encoder. In a cooperative game theory, the Shapley algorithm (e.g., SHAP) may represent a balanced distribution rule that distributes a total gain obtained from cooperation among participants in each game according to a marginal contribution of each of the participants. To consider a contribution of a specific process factor to a quality index of a wafer, an interaction between the specific process factor and other process factors may be considered. That is, how the specific process factor interacts with the other process factors to change the quality index of the wafer may be measured. Accordingly, the Shapley algorithm may calculate a Shapley value representing a contribution that affects the quality index of the wafer for each process factor using the various combinations of the process factors. For example, there may be a case in which there are process factors a, b, and c, and a contribution of the process factor a that affects the quality index of the wafer is measured. In this case, the quality index of the wafer may be predicted with a process factor of (a), a process factor combination of (a, b), and a process factor combination of (a, b, c), respectively, and a Shapley value representing the contribution of the process factor a to the quality index of the wafer may be calculated based on predicted quality indices of the wafer obtained by the predicting and an actual quality index of the wafer. For example, when a Shapley value of a process factor for a wafer is calculated to be 0.3, it may be determined that a quality index of the wafer is increased by the process factor by a value of 0.3. In another example, when a Shapley value of a process factor for a wafer is calculated to be −0.1 may be determined that a quality factor of the wafer was decreased by that process factor by a value of 0.1.

In an example, the electronic device may calculate a Shapley value of one process factor for each wafer by using a transformer encoder included in the trained second neural network. The electronic device may obtain a graph 600 in which points generated by setting a measured value of a target process factor (e.g., a temperature factor) and a Shapley value of the target process factor as x-axis and y-axis coordinates, respectively, for each of a plurality of wafers, are indicated. In the graph 600, an x-axis may indicate a measured value, and a y-axis may indicate a Shapley value.

In an example, the electronic device may calculate a Shapley value for each wafer for several process factors, from among all the process factors, may be selected by the trained first neural network using the transformer encoder (e.g., the transformer encoder 222 of FIG. 2) included in the trained second neural network. The electronic device may select a control factor from among process factors that were selected by the trained first neural network from among all the process factors. The electronic device may calculate, as a final score of a specific process factor, an average of absolute values of Shapley values of the specific process factor calculated for the respective wafers. The electronic device may select the control factor that has a major (i.e., significant or more relevant) influence on a wafer quality factor from among the plurality of process factors by comparing final scores calculated for the respective process factors to each other. In an example, the electronic device may select, as the control factor, a preset number (e.g., 40) of process factors in order from a process factor having the highest final score among the one or more process factors selected by the first neural network.

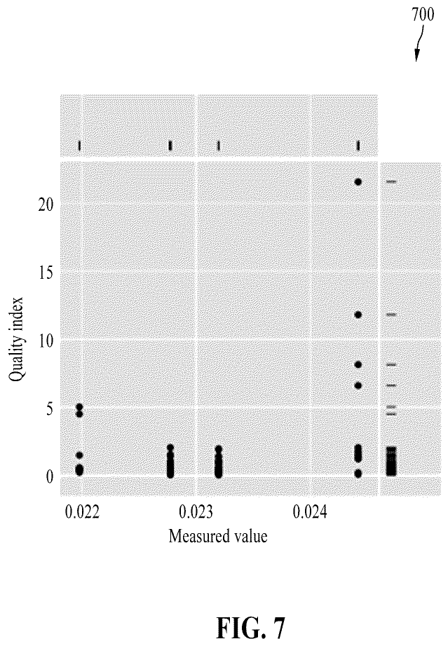

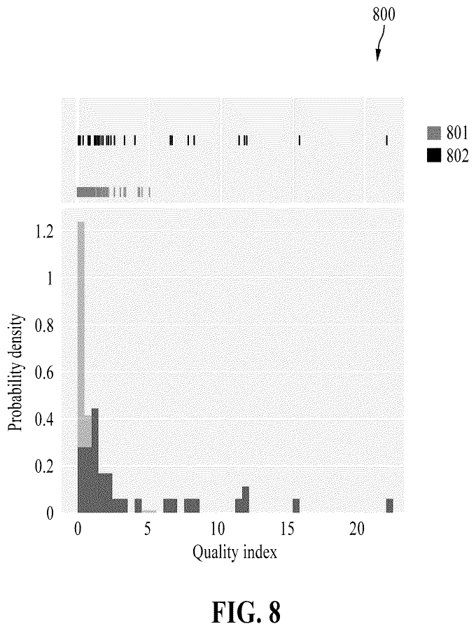

FIGS. 7 and 8 illustrate examples of a control factor, in accordance with one or more embodiments.

Referring to FIG. 7, in a non-limiting example, an electronic device may obtain a graph 700 in which points generated by setting a measured value of a target process factor (e.g., a temperature factor) and a quality index of a wafer by the measured value of the target process factor as x-axis and y-axis coordinates, respectively, for each of a plurality of wafers, are illustrated. In the graph 700, the x-axis may indicate a measured value, and the y-axis may indicate a quality index. Referring to FIG. 6, the electronic device may calculate a Shapley value of the target process factor for each of the plurality of wafers. In this case, where the Shapley value is greater than or equal to zero (0) may indicate that the quality of a wafer is deteriorated by the target process factor, and a Shapley value less than 0 may indicate that the quality of the wafer is improved by one process factor. Referring to FIG. 8, the electronic device may generate a first histogram 801 illustrating a distribution of quality indices of wafers having the Shapley value of less than 0 for the target process factor among the plurality of wafers based on measured values of the target process factor. Similarly, the electronic device may generate a second histogram 802 illustrating a distribution of quality indices of wafers having the Shapley value of 0 or greater for the target process factor among the plurality of wafers based on the measured values of the target process factor. The electronic device may determine whether to select the target process factor as a control factor by comparing the first histogram 801 and the second histogram 802 generated in relation to the target process factor. For example, referring to the first histogram 801 and the second histogram 802 shown in FIG. 8, when the quality indices of the wafers having the Shapley value of less than 0 for the target process factor are distributed closer to 0, compared to the quality indices of the wafers having the Shapley value of 0 or greater for the target process factor, this arrangement may indicate that the lower the quality index the higher the quality of a wafer, and it may thus be determined that the target process factor has a major influence on a quality index of the wafer. In an example, when a value obtained by subtracting a first average of the quality indices of the wafers having the Shapley value of less than 0 for the target process factor from a second average of the quality indices of the wafers having the Shapley value of 0 or greater for the target process factor is greater than or equal to a threshold value, the electronic device may select the target process factor as the control factor.

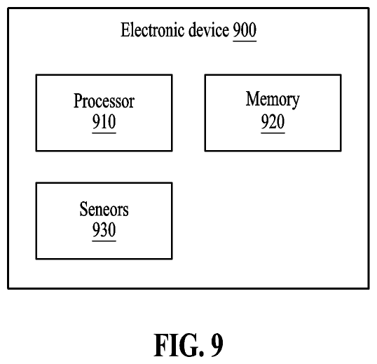

FIG. 9 illustrates an example apparatus with control process and control factor selection according to one or more embodiments.

Referring to FIG. 9, an electronic device 900 may include at least one processor 910, a memory 920, and sensor(s) 930. The description provided with reference to FIGS. 1 to 8 above may also be applied to FIG. 9.

The processor 910 may be configured to execute computer-readable instructions to configure the processor 910 to control the electronic device 900 to perform one or more or all operations and/or methods of the algorithms represented by the operation flows of FIGS. 1-3, and/or as described above as being performed by the electronic devices (such as electronic device 200), and may include any one or a combination of two or more of, for example, a central processing unit (CPU), a graphic processing unit (GPU), and a neural processing unit (NPU), but is not limited to the above-described examples. The processor 910 may also execute programs or applications to control other functionalities of the electronic device. The processor 920 may be configured to train and implement the first and second neural networks.

The memory 920 may store computer-readable instructions. The processor 910 may be configured to execute computer-readable instructions, such as those stored in the memory 920, and through execution of the computer-readable instructions, the processor 910 is configured to perform one or more, or any combination, of the operations and/or methods described herein.

The memory 920 may be a volatile or nonvolatile memory. The memory 920 may include, for example, random-access memory (RAM), dynamic random-access memory (DRAM), static random-access memory (SRAM), or other types of non-volatile memory known in the art. The memory 920 may store any of the neural network models described herein.

In a non-limiting example, the sensor(s) 930 may be the respective sensors at one or more operation stages (e.g., including those represented in FIG. 1), and may include, for example, an electron microscope. In an example, the sensors may be employed to measure an actual quality index of the wafer through an observation of the wafer during and/or after the semiconductor fabrication process (e.g., the exposure process 111, the etching process 112, and the cleaning process 113, etc.). However, examples are not limited thereto.

The neural networks, electronic devices, processors, memories, encoders, electronic device 200, electronic device 900, processor 910, memory 920, sensors 930, transformer encoder 200 and 300 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating sequence data based on measured values of respective one or more process factors of each of a plurality of processes of a semiconductor fabrication process for a wafer within the semiconductor fabrication process;
generating a temporary quality index of the wafer using a second neural network connected to a first neural network that is provided the sequence data;
training the first neural network and the second neural network based on a loss between the temporary quality index and a set actual quality index of the wafer;
selecting a control process from among the plurality of processes using at least one of the trained first neural network and/or the trained second neural network; and
selecting a control factor from among multiple process factors of the selected process using the trained second neural network.

2. The method of claim 1, wherein the first neural network is trained to infer process factors, from among all the process factors belonging to the plurality of processes, that affect quality more than other control factors of the all control factors.

3. The method of claim 1, wherein the second neural network comprises:
a transformer encoder; and
a multi-layer perceptron (MLP).

4. The method of claim 3, wherein the generating of the temporary quality index comprises:
correcting the generated sequence data in response to inputting the sequence data to the first neural network;
generating, by the second neural network, a plurality of embedding vectors by performing linear projection on each of the corrected sequence data to be respective vectors of the plurality of embedding vectors having a preset size; and
generating, by the second neural network, the temporary quality index of the wafer using the MLP provided an output vector of the transformer encoder that is provided the plurality of embedding vectors.

5. The method of claim 4, wherein the transformer encoder performs:
positional encoding on each of the plurality of embedding vectors; and
provides embedding vectors obtained through the positional encoding to the transformer encoder.

6. The method of claim 3, wherein the transformer encoder comprises:
a plurality of encoders, each encoder comprising a multi-head attention layer configured to perform self-attention at least once, the plurality of encoders being connected in series.

7. The method of claim 1, wherein the training comprises:
performing the training of the first neural network and the second neural network together; and
retraining the second neural network using the trained first neural network.

8. The method of claim 1, wherein the selecting of the control process comprises:
selecting a preset number of processes as the control process from among the plurality of processes, in a descending order from a corresponding process that has a greatest number of respective process factors selected by the trained first neural network.

9. The method of claim 1, wherein the selecting of the control process comprises, for each of the plurality of processes:
calculating a respective score indicating an interaction between a corresponding process and other processes for each of plural wafers using a transformer encoder of the trained second neural network;
calculating an average of the respective scores as a respective final score of the corresponding process; and
selecting a preset number of select processes as the control process from among the plurality of processes, in a descending order from a process having a highest respective final score.

10. The method of claim 1, wherein the selecting of the control process comprises:
for each of some process factors selected by the trained first neural network from among all the process factors of the plurality of processes:
calculating a Shapley value of a corresponding process factor for each of plural wafers using a transformer encoder of the trained second neural network;
calculating an average of absolute values of the Shapley values calculated for plural wafers as a respective final score of the corresponding process factor; and
selecting a preset number of select process factors as the control factor from among the some process factors in a descending order according to the respective final score of the select process factors from a process factor having a highest respective final score.

11. An electronic device, the device comprising:
a processor configured to:
generate sequence data based on measured values of respective one or more process factors of each of a plurality of processes of a semiconductor fabrication process for a wafer within the semiconductor fabrication process;
generate a temporary quality index of the wafer using a second neural network connected to a first neural network that is provided the sequence data;
train the first neural network and the second neural network based on a loss between the temporary quality index and a set actual quality index of the wafer;
select a control process from among the plurality of processes using at least one of the trained first neural network or the trained second neural network; and
select a control factor from among multiple process factors of the selected process using the trained second neural network.

12. The device of claim 11, wherein the first neural network is trained to infer process factors, from among all the process factors belonging to the plurality of processes, that affect quality more than other control factors of the all control factors.

13. The device of claim 11, wherein the second neural network comprises:
a transformer encoder; and
a multi-layer perceptron (MLP).

14. The device of claim 13, wherein the generating of the temporary quality index comprises:
correcting the generated sequence data in response to inputting the sequence data to the first neural network;
generating, by the second neural network, a plurality of embedding vectors by performing linear projection on each of the corrected sequence data to be respective vectors of the plurality of embedding vectors having a preset size; and
generating, by the second neural network, the temporary quality index of the wafer using the MLP provided an output vector of the transformer encoder that is provided the plurality of embedding vectors.

15. The electronic device of claim 14, wherein the processor is further configured to:
perform positional encoding on each of the plurality of embedding vectors; and
provide embedding vectors obtained through the positional encoding to the transformer encoder.

16. The electronic device of claim 13, wherein the transformer encoder comprises:
a plurality of encoders, each encoder comprising a multi-head attention layer configured to perform self-attention at least once, the plurality of encoders being connected in series.

17. The electronic device of claim 11, wherein the processor is further configured to:
train both the first neural network and the second neural network together; and
retrain the second neural network using the trained first neural network.

18. The electronic device of claim 11, wherein the processor is further configured to:
select a preset number of processes as the control process from among the plurality of processes, in a descending order from a corresponding process that has a greatest number of respective process factors selected by the trained first neural network.

19. The electronic device of claim 11, wherein the processor is further configured to, for each of the plurality of processes:
calculate a respective score indicating an interaction between a corresponding process and other processes for each of plural wafers using a transformer encoder of the trained second neural network;
calculate an average of the respective scores as a respective final score of the corresponding process; and
select a preset number of select processes as the control process from among the plurality of processes, in a descending order according to the respective final scores of the select processes from a process having a respective highest final score.

20. The electronic device of claim 11, wherein the processor is further configured to:
for each of some process factors selected by the trained first neural network from among all the process factors of the plurality of processes:
calculate a Shapley value of a corresponding process factor for each of wafers using a transformer encoder of the trained second neural network;
calculate an average of absolute values of the Shapley values calculated for the plural wafers as a respective final score of the corresponding process factor; and
select a preset number of select process factors as the control factor from among the some process factors in a descending order according to the respective final scores of the selected process factors from a process factor having a highest respective final score.
